(19) United States
(12) Patent Application Publication
(10) Pub. No.: US 2006/0042841 A1
(43) Pub. Date: Mar. 2, 2006

(54) Powered tug

(76) Inventor: Andrew J. Russell, Chandler, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 10/928,973

(22) Filed: Aug. 27, 2004

(51) Int. Cl. B60D 1/00; B62D 1/00; B62M 7/14

(52) U.S. Cl. 180/13

(57) ABSTRACT

An exemplary apparatus, system and method for towing and transporting articles is disclosed as comprising inter alia: a mounting bracket (120) adapted for attachment to a load; a jack shaft (150, 130) adapted for attachment to the mounting bracket (120); a wheel (140) supported by a wheel assembly at one end of the jack shaft (130), wherein the wheel assembly is configured for rotation about the vertical axis of the shaft (130); a right-angle gear motor (100) configured to provide rotary propulsion of the wheel (140); and a steering extension (160) adapted to permit rotation of the wheel assembly in order to guide the direction of movement for towing. Disclosed features and specifications may be variously controlled, adapted or otherwise optionally modified to improve towing, transportation and/or positioning of load articles for any application or operating environment. Exemplary embodiments of the present invention generally provide for towing and transportation of trailers, such as, for example, vehicle trailers.

### FIELD OF INVENTION

The present invention generally concerns devices, systems and methods for transportation; and more particularly, in various representative and exemplary embodiments, to the towing and maneuvering of trailers, for example.

### BACKGROUND

Trailers are vehicles that may be towed by another vehicle, such as for example, a small open cart or a platform used for transporting a boat. The tow engagement portion of a trailer may often be generally supported by a trailer tongue jack when the trailer is parked or otherwise disengaged with the towing vehicle.

Conventional trailer tongue jacks may be secured to a trailer tongue extension and may be configured with a baseplate at the lower end of the jack to distribute load weight over the ground. Trailer jacks are typically configured in the form of elongated shafts that have an upper portion secured to the trailer tongue extension and a lower portion that may be collapsible. A crank arm that may be rotated about the axis of the jack shaft, or in some cases about a different axis, may be employed to extend or collapse the shaft. Consequently, the elevation of the trailer tongue extension can be varied over a particular range for specific applications.

When a vehicle is re-positioned for engagement with a trailer hitch disposed on the forward end of a tongue extension, careful maneuvering for proper alignment is generally required. For example, a towing vehicle may need to back up numerous times in order to achieve suitable alignment with the trailer hitch and trailer tongue extension.

Typical trailer jacks have a 6″ hard wheel and a manual jack screw. The wheel is generally intended to allow the operator to roll the trailer manually. Due to the design of the wheels, varying transportation surfaces, and high loads on the wheel, it may often be difficult to maneuver a trailer with a conventional trailer jack. For example, backing a vehicle to a trailer and aligning the ball post of the vehicle to the trailer hitch can be quite time consuming. The wheel of conventional trailer jacks is often a poor mechanism for positioning the trailer. Moreover, wheels of existing trailer jacks generally have few features incorporated into their design for steering the jack wheel, inasmuch as most trailer jacks employ a “free castering” element.

Accordingly, a need exists inter alia to provide an improved system by which a trailer tongue extension may be maneuvered so that a trailer hitch may be suitably positioned and aligned for proper engagement with, for example, a ball post of a towing vehicle.

### SUMMARY OF THE INVENTION

In various representative aspects, the present invention provides an apparatus and method for maneuvering and transporting trailers. Exemplary features are generally disclosed as including a mounting bracket adapted for attachment to a trailer; a jack shaft adapted for attachment to the mounting bracket; a wheel supported by a wheel assembly at one end of the jack shaft, wherein the wheel assembly provides rotation about the vertical axis of the shaft; a right-angle gear motor configured to provide rotary propulsion of the wheel; and a steering extension adapted to permit rotation of the wheel assembly in order to maneuver the trailer.

Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside in the details of construction and operation as more fully hereafter depicted, described and claimed—reference being made to the accompanying drawings forming a part hereof, wherein like numerals refer to like parts throughout. Other elements, operational features, applications and/or advantages may become apparent in light of certain exemplary embodiments recited in the Detailed Description, wherein:

FIG. 1 representatively illustrates a three-quarter, perspective view of a tug device in accordance with an exemplary embodiment of the present invention;

FIG. 2 representatively illustrates a front view of a portion of the device generally depicted in FIG. 1 in accordance with another exemplary embodiment of the present invention;

FIG. 3 representatively illustrates a side view of the device generally depicted in FIG. 1 in accordance with another exemplary embodiment of the present invention;

FIG. 4 representatively illustrates a top view of the device generally depicted in FIG. 1 in accordance with another exemplary embodiment of the present invention;

FIG. 5 representatively illustrates a top view of the device generally depicted in FIG. 1 in accordance with yet another exemplary embodiment of the present invention;

FIG. 6 representatively illustrates a side view of the device generally depicted in FIG. 1 in an at least partially retracted position in accordance with another exemplary embodiment of the present invention;

FIG. 7 representatively illustrates a side view of the device generally depicted in FIG. 1 in a stowed position in accordance with another exemplary embodiment of the present invention; and

FIG. 8 representatively illustrates a three-quarter, perspective view of an alternative positioning of the tiller arm of the device generally depicted in FIG. 1 in accordance with yet another exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are generally used for distinguishing between similar elements and not necessarily for describing a sequential or chronological order. Moreover, the terms “front”, “back”, “top”, “bottom”, “over”, “under”, and the like, if any, are generally employed for descriptive purposes and not necessarily for comprehensively describing exclusive relative position or order. Any of the preceding terms so used may be interchanged under appropriate circumstances such that various embodiments of the invention described herein, for example, are capable of operation in orientations and environments other than those explicitly illustrated or otherwise described.

### DETAILED DESCRIPTION OF EXEMPLARY EMBODIMENTS

The following descriptions are of exemplary embodiments of the invention and the inventor's conception of the best mode and are not intended to limit the scope, applicability or configuration of the invention in any way. Rather, the following Description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely an apparatus and method for towing and maneuvering trailers, is provided as a specific enabling disclosure that may be readily generalized to any application of the disclosed device, system and method for transporting load articles.

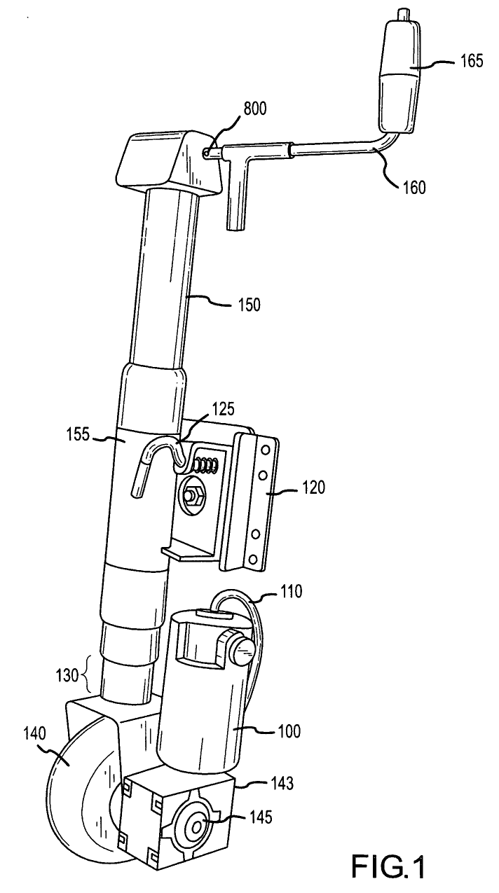

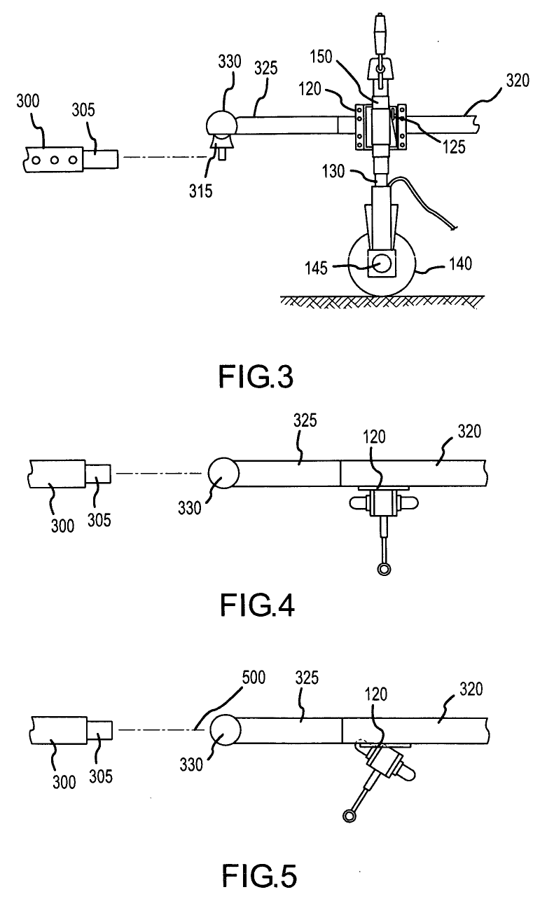

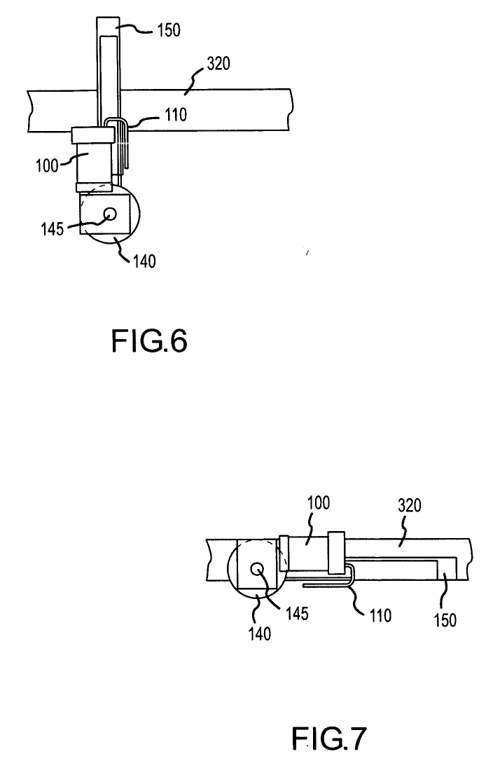

In accordance with various representative and exemplary embodiments, the present invention provides a trailer tug jack (FIG. 1) for a trailer tongue extension 320 and hitch 325 configured for attachment with a ball post 315 affixed to a towing vehicle 300. The disclosed trailer jack device (FIG. 1) comprises a mounting bracket 120 that may be attached to a trailer. A jack shaft (150, 130) is affixed to the bracket with the shaft (150, 130) and/or mounting bracket components pivotal between at least two of a first position for operational towing of a load (see FIG. 3), a second position that comprises at least partial retraction of at least a portion of the jack shaft (see FIG. 6), and a third position corresponding to stowage of the jack shaft (see FIG. 7). In certain exemplary applications, the first position may be pivotally substantially equivalent to the second position and/or the second position may be pivotally substantially equivalent to the third position. In general, however, the first position is that for which the disclosed trailer jack may be used when the trailer is a rest and/or when the trailer tug is used to align and engage the trailer hitch 325 to a ball post 315 of a towing vehicle 300.

The jack shaft may be configured with an upper portion 150 and an at least partially telescoping lower portion 130. The jack shaft may also be configured to comprise a hand crank (160, 165) at the upper end of the jack shaft 150 that may be used to articulate telescopic extension or retraction of the lower portion of the jack shaft 130 with respect to the upper portion 150. Accordingly, the elevation of the trailer tongue extension 320 may be altered in order to assist with engagement of the trailer hitch 325 with the receiving ball post 315 of the towing vehicle 300. The lower portion of the jack shaft 130 may be suitably adapted to provide for rotation of a wheel 140 and/or wheel assembly about the principle (i.e., vertical) axis of the jack shaft (150, 130). Alternatively, conjunctively and/or sequentially, the upper portion of the jack shaft 150 may be rotatably connected with the mounting bracket 120 about the principal axis (e.g., vertical axis) of the jack shaft. Configured as such an embodiment, jack shaft 130 may be made to disallow rotation about the primary axis relative to the upper portion 150 and the lower portion 130 may telescope relative to the upper portion 150 by means previously described. In general, the wheel assembly is distally disposed at the lower end of the jack shaft 130. A right-angle gear motor 100, for example, may be attached directly to the wheel 140 or to a drive gear. In the case of a drive gear, the gear may be mechanically connected with the wheel 140. In an alternative exemplary embodiment, a chain or drive belt may be configured for attachment with the drive gear and/or the wheel 140. In another representative embodiment, the drive gear may be connected with, for example, an axle gear. This may be accomplished, for example, by the drive gear directly meshing with another gear driven thereon, or alternatively, with an intermediate gear that may be employed so as to provide a mechanical advantage between the drive gear and the gear driven thereon.

High loading of wheel 140 and various surface topologies, combined with extremely high torque input and shearing action of steering, were observed to separate the wheel from the hub in several preliminary embodiments. Numerous tests were performed to determine an appropriate combination of materials to provide acceptable performance over a broad range of practical conditions. Accordingly, wheel 140 may be comprised of a machined or cast metal (e.g., aluminum, steel, etc.) hub with a relatively high tensile strength liquid cast polyurethane wheel tread on the outer portion, wherein the thickness of the polyurethane maybe up to approximately 15% to about more than 22% of the total diameter of the wheel and providing a shore hardness in the range of up to approximately 80 to about more than 95 Durometer. Alternatively, conjunctively or sequentially, the hub may be cast from any polymeric material that is suitably adapted to provide sufficient support that may be desirable for loading, torsion and adhesion. Additionally, the polymeric material may be suitably configured to comprise UV inhibitors, thereby providing another exemplary embodiment suitably adapted for outdoor use, for example. In a representative and exemplary application in accordance with one embodiment of the present invention, wheel 140 may comprise a high grade liquid cast polyurethane having a hardness in the approximate range of about 90 to about 95 Durometer (Shore A) with an elongation at break of approximately 430%, a tensile strength in the approximate range of about 7000 to about 7400 psi, a tear strength of about 700 pli. (DIE C), and an abrasion resistance on the order of about 5 to about 10 times that of standard urethane.

In accordance with an exemplary and representative embodiment of the present invention, FIG. 1 illustrates a powered trailer tug device comprising a jack and powered wheel. The tug generally allows a trailer to be maneuvered substantially independently of the tow vehicle; for example, permitting the trailer to be driven to the towing vehicle ball post. The disclosed tug also generally allows the trailer and load to be easily maneuvered into tight spaces without the requirement of a tow vehicle.

The wheel 140 is driven by a very high-torque, right-angle drive electric gear motor 100. The jack may be either manual or electric. In an exemplary embodiment, gear motor 100 may comprise a reversible electric gear motor. The wheel axle centerline 145 is centered to the vertical axis of the jack shaft 150, 130. The axle is keyed to both the wheel 140 and the gear motor 100 and driven directly from the gear motor 100. Alternatively, the gear motor 100 could be offset from the drive wheel and engaged to the wheel 140 via a chain, belt, sprocket and/or gear assembly. The axle rotation and loading may be transferred to the jack through axle bearings maintained in, for example, an integrated axle and gear motor support assembly 143.

Electric gear motor 100 may also be configured with a power cord 110 for delivery of electric current to gear motor 100 from a garage AC wall outlet, a battery, a power outlet of the towing vehicle, a power outlet integrated into the trailer, a power outlet integrated into a vehicle supported by the trailer and being towed by the towing vehicle, and/or the like.

The lower portion of jack shaft 130 may be configured to be at least partially collapsible with respect to the upper portion of jack shaft 150. Collar 155 general provides axial rotation of jack shaft 150 relative to mounting plate 120, alignment and containment of jack shaft (150, 130), as well as a point of attachment for mounting plate 120. Mounting plate 120 may comprise a quick-release element 125 for attachment/disengagement as well as to permit/lock pivoting of jack shaft (150, 130) about an axis substantially normal to mounting plate 120, for example.

An integrated tiller-extension/crank-arm 160 may be provided to allow for steering as well as for retracting and/or extending jack shaft 130. Configured as such an embodiment, lower jack shaft portion 130 may be made to disallow rotation about the primary axis relative to jack shaft upper portion 150 and lower portion 130 may telescope relative to upper portion 150 by means previously described. A tiller/crank handle 165 may be attached to a portion of the steering extension 160 so as to provide a steering arm (e.g., tiller) to maneuver the drive wheel 140. This may be accomplished, for example, with a center bored hole through the internal jack screw with the tiller shaft through the bore hole and affixed to the integral axle and gear motor support assembly. Alternatively the entire assembly may be rotated by affixing the tiller handle to the outer casing or assembly thereto attached and the outer casing attached to the trailer frame mount via a sleeve and bearing bracket arrangement 155, for example. The tiller may comprise drive wheel motor controls as well.

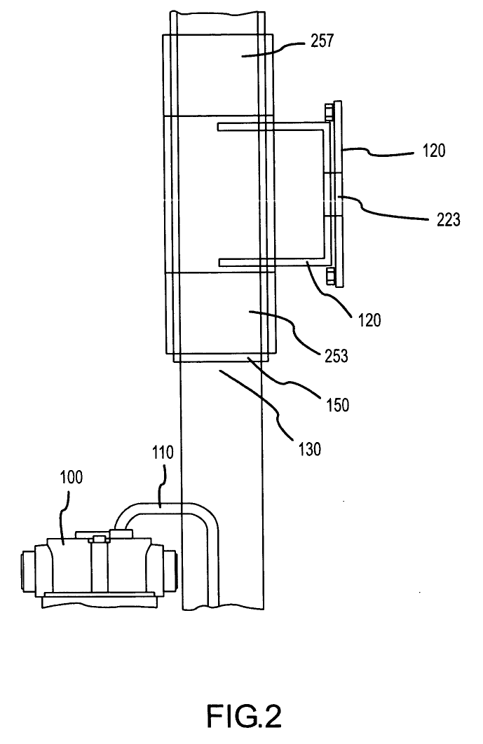

In accordance with another exemplary embodiment, as generally depicted in FIG. 2 for example, a sleeve and bearing bracket arrangement may comprise an upper bearing assembly 257 and lower bearing assembly 253 affixed to jack shaft 150 and entrapping shaft collar and bracket assembly 155. Bearing assemblies 257 and 253 generally provide jack shaft (150, 130) alignment as well as support of normal bearing load (e.g., weight) of tongue 320 and reduction of rotational friction corresponding to rotation of jack shaft (150, 130) within collar 155 for steering of the wheel assembly. Additionally, FIG. 2 shows a bracket pivot element 223 for mounting bracket 120. Bracket pivot 223 generally allows the jack assembly to rotate into storage and usage positions. In various representative applications of the present invention, bracket pivot 223 may be supplied as standard equipment with the trailer tug device, or may alternatively be supplied as an OEM product.

As generally depicted in FIGS. 3, 4 and 5, the trailer tug device disclosed herein as an exemplary embodiment of the present inventions may be used for alignment of a trailer hitch 325 with a ball post 315 supported by a tongue extension 305 affixed to towing vehicle 300. Trailers of the type typically towed by vehicles may include mobile homes, boat trailers, livestock trailers, construction trailers, gardening trailers, and/or the like. A vehicle trailer hitch typically includes a fixed portion that may be secured to the rear end of the towing vehicle 300 with a removable telescoping portion 305 configured with a trailer hitch ball post 315 secured, for example, by a nut. The upper segment of trailer hitch ball post 315 is typically a volumetrically spherical section. Telescoping portion 305, in addition to other parts of the trailer hitch that may be attached to it, can be remove from the fixed towing vehicle portion 300 when the trailer hitch is not in use.

The towing vehicle 300 trailer hitch (305, 315) is representatively illustrated to show a particular operating environment in which the invention may be utilized. A conventional trailer has a horizontally extending trailer tongue 320 with a trailer hitch 325 at the forward end that includes a ball post receiving well 330 for engagement with towing vehicle 300 ball post 315. Alignment problems may occur with conventional trailer jacks when attempting to connect a trailer to a vehicle; especially when the trailer hitch 325 is to be aligned above ball post 315 before the trailer may be coupled to the towing vehicle 300. Various representative and exemplary embodiments of the present invention provide improved means for interconnecting a towing vehicle 300 with a trailer hitch 325.

FIGS. 3 and 4 show wheel assembly and wheel 140 aligned with respect to tongue extension 320 such that if gear motor 100 is engaged to rotationally propel wheel 140, the trailer would move in a direction co-parallel with the principle axis of tongue extension 320. To align ball receiving well 330 of trailer hitch 325 with ball post 315, the trailer tongue extension 320 must be moved not only forward, but also non-orthogonally in the direction indicated 500, for example, as generally depicted in FIG. 5. By steering jack shaft (150, 130) in the indicated alignment and engaging right-angle motor 100, wheel 140 will move the trailer and trailer hitch 325 so that the ball post receiving well 330 can be moved substantially over ball post 315. Thereafter, the lower portion of jack shaft 130 may be at least partially retracted so as to reduce the elevation of trailer tongue extension 320, so that the ball post receiving well 330 comes to settle over and engage ball post 315. Conventional trailer hitches typically have mechanisms for securing the hitch to the towing vehicle ball post (not illustrated in the Figures). In general, the disclosed tug device (see FIG. 1) may be affixed by means of mounting plate 120 to a trailer tongue extension 320 such that ball post receiving well 330 of trailer hitch 325 may be aligned 500 and subsequently engaged with the towing vehicle 300 ball post 315.

FIG. 6 generally depicts the tug device representatively illustrated for example in FIG. 1 in a partially retracted position of the lower portion of jack shaft 130 in accordance with an exemplary embodiment of the present invention. FIG. 7 generally depicts the tug device representatively illustrated in FIG. 6 in a jack shaft stowage position in accordance with another exemplary embodiment of the present invention.

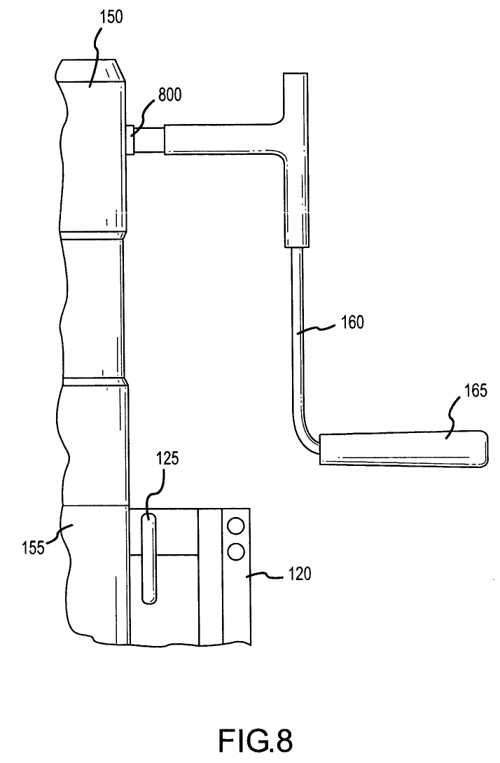

FIG. 8 representatively illustrates an exemplary embodiment, in accordance with the present invention, wherein steering extension 160 (e.g., “tiller arm”) may be configured with a pivoting attachment 800 with respect to jack shaft 150 such that steering extension 160 may also function as a hand crank for articulating extension/retraction of the lower portion of jack shaft 130. Accordingly, crank handle 165 may be revolved about an axis substantially perpendicular to the principle axis of jack shaft (150, 130) in order to extend or retract drive wheel 140 from engagement with the ground. Extension or retraction may be obtained by a gearing configuration between crank arm 160 and, for example, a threaded member within upper jack shaft 150 and via a connecting shaft 800 (not illustrated in the Figures).

In the foregoing specification, the invention has been described with reference to specific exemplary embodiments; however, it will be appreciated that various modifications and changes may be made without departing from the scope of the present invention as set forth in the claims below. The specification and Figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any device claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

1. A powered tug device suitably adapted for towing loads of at least 500 lbs. on moderate grade, said device comprising:
a mounting bracket, said mounting bracket suitably adapted for attachment to a load;
a shaft having a principle axis, said shaft suitably adapted for attachment to said mounting bracket;
a wheel assembly disposed at one end of said shaft;
a wheel supported by said wheel assembly;
at least one of said wheel and said wheel assembly suitably configured for rotation about the principle axis of said shaft;
a motor, said motor suitably configured for providing rotary propulsion of said wheel, said motor comprising at least one of an electric motor, a gear motor, a reversible gear motor and a right-angle gear motor; and
a steering extension suitably configured for providing rotation of said wheel assembly, said steering extension comprising at least one of an arm, a steering wheel, and a tiller.

2. The device of claim 1, wherein said shaft is suitably configured to provide at least partially telescoping retraction of at least a portion of said shaft.

3. The device of claim 2, wherein said shaft is pivotally attached to said mounting bracket and said shaft may be pivoted between at least two positions corresponding to a first position for towing said load, a second position corresponding to at least partial retraction of said shaft, and a third position corresponding to stowage of said shaft.

4. (canceled)

5. The device of claim 2, wherein at least one of:
said steering extension is suitably adapted for removable engagement with said shaft;
said steering extension optionally comprises drive wheel motor controls; and
said steering extension further comprises a crank handle for at least one of manual extension and manual retraction of said partially retractable shaft.

6. The device of claim 2, wherein said partially retractable shaft is at least one of manually actuated, hydraulically actuated and electrically actuated.

7. The device of claim 1, wherein:
the wheel axle centerline is substantially centered on the principal axis of said shaft;
the axle is substantially driven by said motor; and
the axle is engaged with said motor by at least one of a gear, a sprocket, a chain and a belt.

8. The device of claim 1, further comprising an integrated axle and gear motor assembly, wherein at least one of axle rotation and axle load is at least partially supported by axle bearings.

9. A method for towing a load of at least 500 lbs. on moderate grade, said method comprising the steps of:
providing a mounting bracket, said mounting bracket suitably adapted for attachment to a load;
providing a shaft, said shaft suitably adapted for attachment to said mounting bracket;
providing a wheel assembly disposed at one end of said shaft;
providing a wheel supported by said wheel assembly;
at least one of said wheel and said wheel assembly suitably configured for rotation about the principle axis of said shaft;
providing an electric motor, said electric motor suitably configured for rotary propulsion of said wheel; and
providing a steering extension suitably configured for rotation of said wheel assembly.

10. The method of claim 9, wherein said shaft is suitably configured to at least partially retract.

11. The method of claim 10, wherein said shaft is pivotally attached to said mounting bracket, and said shaft may be pivoted between at least two positions corresponding to a first position for towing said load, a second position corresponding to at least partial retraction of said shaft, and a third position corresponding to stowage of said shaft.

12. The method of claim 10, further comprising the step of at least one of manual extension and manual retraction of said partially retractable shaft.

13. The method of claim 10, further comprising the step of at least one of manual actuation, hydraulic actuation and electrical actuation of said partially retractable shaft.

14. A method for towing a trailer load of at least 500 lbs. on moderate grade, said method comprising the steps of:
providing a shaft attached to a trailer;
providing a wheel assembly distally disposed at one end of said shaft;
providing a wheel supported by said wheel assembly;
at least one of said wheel and said wheel assembly suitably configured for rotation about the principle axis of said shaft;
providing an electric motor, said electric motor suitably configured for rotary propulsion of said wheel;
providing a steering extension suitably configured for rotation of said wheel assembly; and
moving said trailer by at least one of actuating said electric motor and actuating said steering extension.

15. The method of claim 14, further comprising the steps of:
attaching a mounting bracket to said trailer; and
attaching said shaft to said mounting bracket.

16. A trailer tow device suitably adapted for towing loads of at least 500 lbs. on moderate grade, said device comprising:
a shaft having a principle axis, said shaft suitably adapted for attachment to said trailer;
a wheel assembly disposed at one end of said shaft;
a wheel supported by said wheel assembly;
at least one of said wheel and said wheel assembly suitably configured for rotation about the principle axis of said shaft;
an electric motor, said electric motor suitably configured for providing rotary propulsion of said wheel; and
a steering extension suitably configured for providing rotation of said wheel assembly.

17. The device of claim 16, wherein at least one of:
said shaft is suitably configured to provide at least partially telescoping retraction of at least a portion of said shaft; and
said wheel comprises a metallic wheel coated with a polymeric material.

18. The device of claim 17, wherein at least one of:
said shaft is suitably adapted for pivotal attachment to a mounting bracket, wherein said shaft may be pivoted between at least two positions corresponding to a first position for towing said trailer, a second position corresponding to at least partial retraction of said shaft, and a third position corresponding to stowage of said shaft; and
said polymeric material comprises a high grade liquid cast polyurethane having a hardness in the approximate range of about 90 to about 95 Durometer with an elongation at break of approximately 430%, a tensile strength in the approximate range of about 7000 to about 7400 psi, a tear strength of about 700 pli, and an abrasion resistance in the rang of about 5 to about 10 times that of standard urethane.

19. The device of claim 16, wherein said electric motor comprises at least one of a gear motor, a reversible gear motor and a right-angle gear motor.

20. The device of claim 16, wherein:
the wheel axle centerline is substantially centered on the principal axis of said shaft;
the axle is substantially driven by said electric motor; and
the axle is engaged with said electric motor by at least one of a gear, a sprocket, a chain and a belt.
